(19) United States
(12) Patent Application Publication
(10) Pub. No.: US 2018/0297315 A1
(43) Pub. Date: Oct. 18, 2018

(54) FOLDING BELT FOR A DEVICE FOR FOLDING FOLDING-BOX BLANKS

(71) Applicant: Wilhelm Bahmüller Maschinenbau Präzisionswerkzeuge GmbH, Pluederhausen (DE)

(72) Inventors: Thomas STOBER, Urbach (DE); Jan UNDEUTSCH, Backnang (DE)

(73) Assignee: Wilhelm Bahmüller Maschinenbau Präzisionswerkzeuge GmbH, Pluederhausen (DE)

(21) Appl. No.: 15/766,566

(22) PCT Filed: Aug. 22, 2016
(86) PCT No.: PCT/EP2016/069817

§ 371 Date: Apr. 6, 2018

(30) Foreign Application Priority Data
Oct. 6, 2015 (DE) 10 2015 219 238.5

(51) Int. Cl. B31B 50/58; B65H 45/22

(52) U.S. Cl. CPC B31B 50/58; B31B 2100/0022; B65H 45/22

(57) ABSTRACT

The invention relates to a folding belt, which can be used, for example, in a folding machine. By means of an improved profile of the folding belt, the quality of the folding is improved and, in particular, undesired “fishtailing” is reduced.

### BACKGROUND OF THE INVENTION

The invention proceeds from a folding belt as disclosed in DE 39 08 981 A1.

DE 44 12 857 A1 discloses a folding machine comprising a folding belt, the folding belt of which has a triangular cross section or a ridge-like cross section. This “ridge” is on the outside of the folding belt. Contact between the folding belt and the folding-box blank occurs exclusively at this location.

U.S. Pat. No. 4,614,512 discloses a folding machine comprising a folding belt, the folding belt of which has a trapezoidal cross section. This folding belt runs over rollers that are offset from one another such that the folding belt moves along a helix. There is contact between the folding belt and the folding-box blank over the entire width of the folding belt.

Folding-box blanks are flat blanks made of corrugated board that represent a flat pattern of the finished folded box. In order for it to be possible to erect the folding-box blanks as cartons for packing, said blanks must be shaped into folding-box tubes that comprise interconnected edges along a line. For this purpose, the folding-box blanks are bent along pre-grooved folding lines that form two edges on the erected box or carton, which edges extend between the base and the lid. The parts to be folded inwards are referred to as side flaps and are both a narrow flat side and a wide flat side of the subsequent carton. Large tabs, which form parts of the base or lid and are connected to the central piece merely by means of the subsequent side walls, hang from the side flaps.

In order to fold these side flaps inwards in order to form the folding-box tube, folding belts are used that have a helical extension. In this way, the side flap, which initially lies flat, is gripped synchronously with the forward movement from below and folded down according to the extent of the advancing movement through the machine. The arrangement and shape of the folding belt is selected such that the surface of the folding belt that rests against the side flap and folds the side flap forms a straight helix. This helix ensures that the advancing edge of the folding-box blank is folded inwards to a greater extent than the lagging part. In particular in the case of large folding boxes, this means that the side flap is not bent over exactly following the pre-grooved folding line, but rather that the actual folding line is further to the center in the region of the advancing edge of the blank than in the rear region, as a result of which the folded-in side flaps do not coincide exactly. This results in “fishtailing”.

In order to prevent this fishtailing, DE 39 08 981 A1 discloses a folding belt that can transmit forces required for folding to the folding-box blank and is simultaneously flexible enough to run over the return rollers of the folding machine using minimal expenditure of force. This folding belt has proved successful and is still used today, more than 25 years after the

Over time, the quality of corrugated board has deteriorated; at the same time, some customers expect multi-color printed cartons having a flawless printed surface.

### SUMMARY OF THE INVENTION

Proceeding from this, the object of the invention is to provide a further improved folding belt, through the use of which the side flaps of the folding-box blanks are folded very precisely along the pre-grooved folding line, even if the quality of the corrugated board is poor, and without damaging the surface of the folding-box blanks.

According to the invention, this object is achieved by a folding belt having the features of claim 1.

As a result of the cross-sectional profile according to the invention of the folding belt, the belt rolls over the (printed) surface of the side flap during the folding process, such that there is no damage to the surface. At the same time, there is linear contact between the folding belt and the side flap, such that there is no local overstress or pressure marks on the corrugated board. This linear contact (line of contact) between the folding belt and the side flap extends along the entire length of the side flap that is folded down by the folding belt. The line of contact extends approximately in parallel with the folding edge, along which edge the side flap is folded down.

As a result, the cartons produced using the folding belt according to the invention meet all the requirements with regard to precision (no “fishtailing”) and surface quality.

Another advantage of the folding belt according to the invention can be seen in the fact that pre-existing machines can be retrofitted with said belt. The quality of the cartons folded in retrofitted machines can thereby be significantly improved.

Because the folding belt according to the invention is installed in folding machines that have been known for a long time, a detailed description of these machines is dispensed with and instead reference is made to DE 39 08 981 A1, the content of which is part of this application by reference.

The folding belt according to the invention can run in a crossed manner, in which the folding belt runs over two rollers in this case, the axes of which rollers are at an angle to one another that approximately corresponds to the angle of the expected fold. In this arrangement, a somewhat greater force is applied to the belts; however, in this arrangement and by using the folding belt according to the invention, the load on the surface of the side flap to be folded is minimal.

Alternatively, the folding belts may run over rollers having axes that are oriented substantially mutually in parallel, such that the belt runs in an uncrossed manner. In this arrangement, the belt is practically not stressed in order to twist; instead, a relative movement takes place, transversely to the direction of transport of the blank, between the side flap and the contact surface of the folding belt during the folding movement, as a result of which the surface of the side flap and of the folding belt is subject to abrasion.

In both of the embodiments, the contact surface or part of the contact surface is designed such that if the apex of the profile is above the axis that is furthest upstream, a surface is produced that is identical to the initial state of the side flap in this position. If the belt is crossed, the flat surface produced remains as far as the next return roller.

In the uncrossed arrangement, two folding belts are in any case required, one behind the other, on each side of the device in order to fold the side flap by 180°. If the folding belt is crossed, a fold by 180° can be achieved using a folding belt on each side.

There are various options for designing the curved portion according to the invention in the profile of the folding belt.

The aim is that during the folding process, the folding belt rests against the side flap as far as possible over the entire length thereof and the contact line between the folding belt and the folding-box blank does not “migrate” transversely to the direction of transport of the folding-box blank. These undesired relative movements lead to signs of abrasion on the printed outer surface of the side flap and thereby have an adverse effect on the visual quality thereof.

It has proven to be advantageous if the tangents at the start and end of the curved portion enclose an angle of 90°, 75°, 60°, or less. A minimum angle of 30° is advantageous in most cases.

By nature, this angle depends on the angle by which the side flap is to be folded. In principle, the more the side flap is to be folded, the greater the angle between the tangents.

It has proven to be advantageous for the tangent at the start of the curved portion to extend in parallel with the back of the folding belt. The profile according to the invention then comes to rest gently against the side flap to be folded and a folding process begins without impact loading.

It is also possible for the tangent at the start of the curved portion and the back of the folding belt to enclose an angle between 5° and 45°.

The curved portion may have the shape of a circular segment, an elliptical segment, or another polynomial of the second order. Selecting the appropriate shape depends on the circumstances of the individual case and may have to be determined by trial and error.

In order to simplify production of the profile according to the invention, it is also possible that a polygon having at least three straight lines in the cross section, but preferably having more than five straight lines, is brought into close proximity to the curved portion. As a result, the significant advantages of the profile according to the invention are almost completely achieved.

The profile according to the invention is preferably made of a flexible material, such as a closed-pore foam.

A folding belt that is light and runs easily around the end rollers is obtained if at least one strip designed so as to correspond to the profile is provided on the back of the folding belt instead of a solid profile, the narrow side of which strip that faces away from the back of the belt, forms the contact surface.

The bending resistance when being deflected around the end axes can be lowered further if the strip on the back of the folding belt is undulating or meandering. When running around the end axes, practically no tensile stresses arise in the region of the contact surface. Furthermore, a particularly stable contact surface can be obtained if two undulating or meandering strips are provided on the back of the folding belt, which strips are preferably arranged such that the convex bulges thereof facing one another collide above the center of the folding belt.

### BRIEF DESCRIPTION OF THE DRAWINGS

Embodiments of the subject matter of the invention are shown in the drawings, in which:

FIG. 1 shows FIG. 2 of DE 39 08 981 A1 (prior art),

FIG. 2 shows FIG. 11 of DE 39 08 981 A1 (prior art),

FIG. 3 shows FIG. 4 of DE 39 08 981 A1 (prior art),

FIGS. 4 and 5 are cross sections of folding belts according to the invention,

FIG. 6 is an isometric and simplified illustration of a folding process in three different steps (I, II and III),

FIG. 7 is sections, belonging to step I, along lines A-A and B-B,

FIG. 8 is sections, belonging to step II, along lines A-A and B-B,

FIG. 9 is sections, belonging to step III, along lines A-A and B-B, and

FIG. 10 is an isometric and simplified illustration of a folding process comprising folding two folding-box blanks in each step.

### DESCRIPTION OF THE EMBODIMENTS

Like reference signs are used throughout for like components.

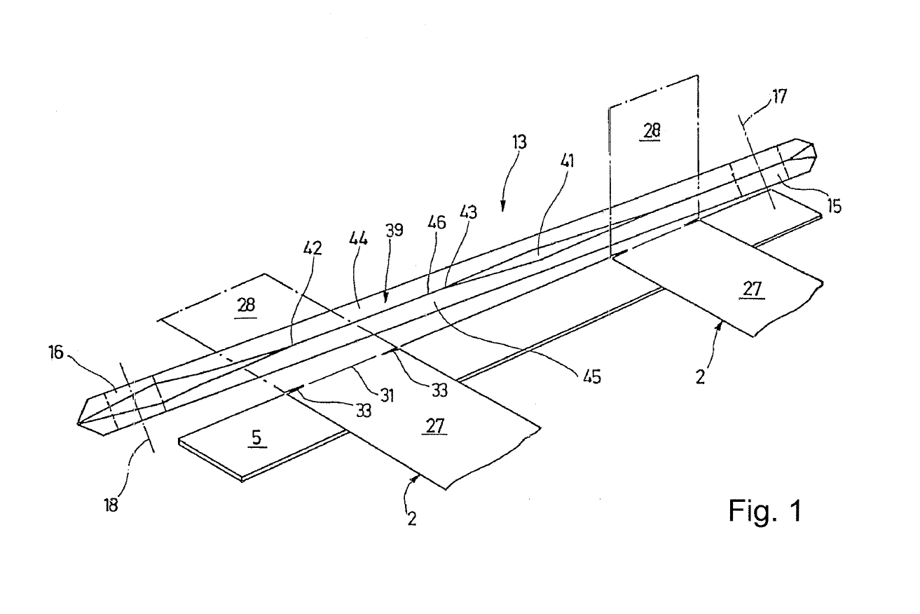

As is already known from DE 39 08 981 A1, a folding machine comprises two continuous folding belts 13, which, in their general extension, begin at the side underneath a guideway 5 and end at the side above the guideway 5. The two folding belts 13, only one of which is shown in FIG. 1, are mirror-symmetric with respect to the longitudinal axis of the folding machine.

The folding belt 13 on the left side of the folding machine, viewed in the direction of movement of the folding-box blanks 2, runs around two pulleys 15 and 16, which are rotatably mounted on axes 17 and 18 of the base frame. One of the pulleys 15 or 16 is coupled to a drive device in order to move the folding belt 13 synchronously with the toothed belts (not shown) responsible for feeding the folding-box blanks. The axes 17 and 18 extend mutually in parallel and at an angle of 45° relative to the plane defined by the guideways 5. The orientation of the axes 17 and 18 is such that they point downwards in the direction of the plane of symmetry of the folding machine 1.

In the direction of transport of the folding-box blanks 2, even more pairs of folding belts (not shown) according to the invention may be arranged behind the folding belt 13. These folding belts extend substantially as a continuation of the folding belt 13 and continue the folding movement. This process and the arrangement of the folding belts is described in detail in DE 39 08 981 A1.

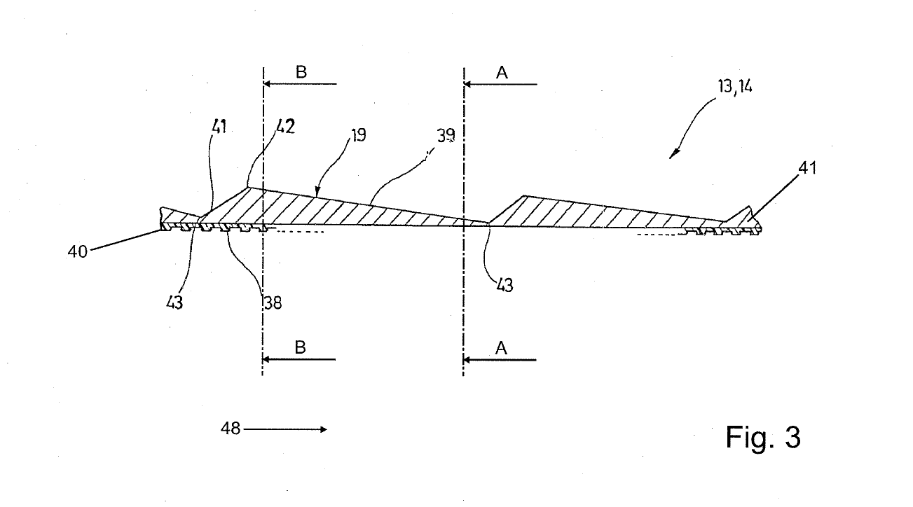

Due to the arrangement of the total of four or more folding belts, a tight side is produced on each of the folding belts 13, which side runs in the direction of the transport movement of the folding-box blanks 2 and interacts with the folding-box blank 2, while a slack side runs back in the opposite direction without touching the folding-box blank 2. The direction of the transport movement and of the tight side is shown in FIGS. 3, 6 and 10 by an arrow 48.

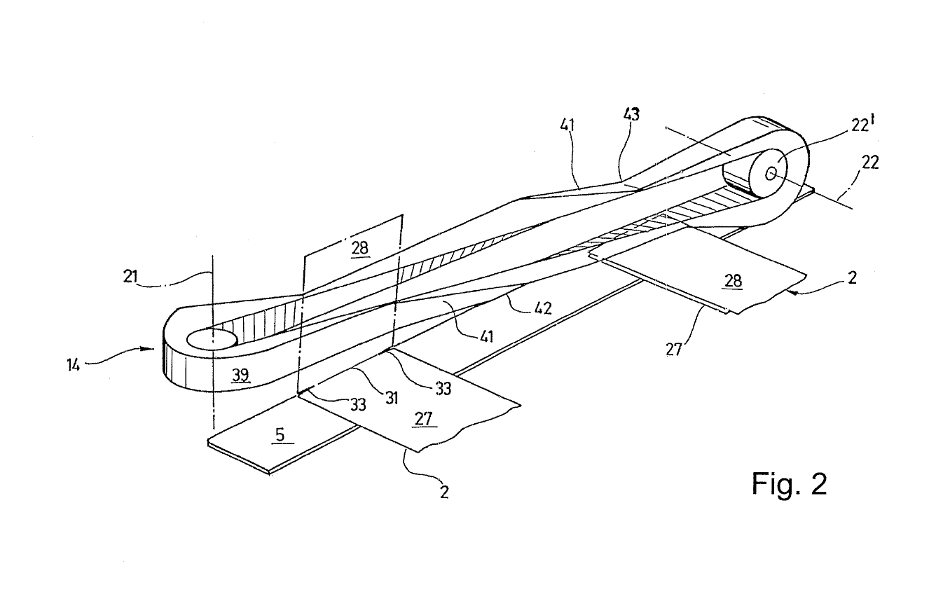

FIG. 2 shows a configuration in which the following folding belt 14 is crossed by way of example. In the case of the following folded belt 14 (according to FIG. 11 of DE 39 08 981 A1), the same profile is used; only the axes 21, 22 are oriented differently. The axis 21 is arranged vertically next to the guideway 5, whereas the axis 22 of the return roller 22′ located further upstream is above the guideway 5. The relevant return roller 22′ is moved, relative to the folding line 31, to the center of the folding machine 1 so that the pressure can be applied to the left folding belt 14 on the right of the folding line 31. The height of the axis 22 above the guideway 5 corresponds to the radius of the return roller 22′ in addition to the height of the apex 42 above the front 38 of the toothed belt.

In this arrangement, the first folding belt 13 raises the side flap 28 vertically, because the contact points between the bearing surface according to the invention of the folding belt and the side flap 28 moves upwards along an ascending helix. At the same time, the contact surface rolls over the side flap 28 without any appreciable relative movement between the bearing surface according to the invention of the folding belt and the side flap 28. This protects the (printed) side flap 28 and prevents signs of abrasion on the side flap 28.

The second folding belt 14 then bends (as can be clearly seen in FIG. 2) the side flap 28 towards the central piece 27.

The longitudinal profile 19 on the back of the folding belts 13, 14 will be explained below with reference to FIG. 3. In the longitudinal section or the side view of the folding belts 13, 14, the profile is sawtooth-shaped and is located on the back of a toothed belt 40, which therefore ensures the positive and thus slip-free movement of the folding belts 13, 14.

The toothed side of the toothed belt 40 is referred to as the front 38. The sawtooth-shaped profile 19 is arranged on the back of the toothed belt 40. Said profile consists, in the longitudinal section, of a comparatively minimally inclined bearing surface 39 and a greatly inclined rear surface 41. An apex 42 of the profile is between the bearing surface 39 and the rear surface 41 in each case, while the rear surface 41 and the bearing surface 39 are delimited at the other two ends by two minima 43. This profile design is arranged multiple times along the folding belts 13, 14, the distance between two minima 43 corresponding to the distance from center to center of two consecutive folding-box blanks 2, which comprise, when viewed in the direction of transport of the folding-box blanks 2, the maximum dimensions that can be processed on the folding machine 1.

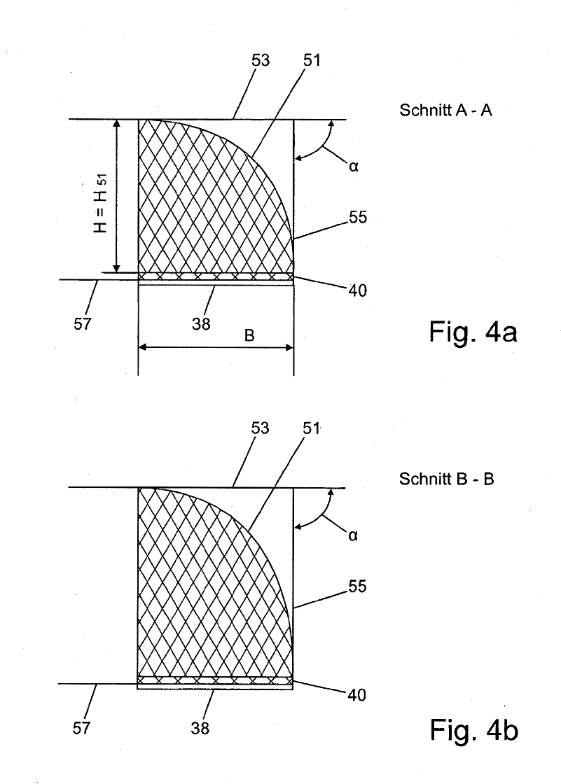

FIG. 4a is a section through the folding belts 13, 14 according to the invention along the line A-A in FIG. 3.

A profile 19 according to the invention is formed on the back of the toothed belt 40. Said profile is made from a flexible and resilient material. Closed-pore plastics foams, such as polyurethane, have proven to be suitable materials.

A new feature of this profile 19 is that it comprises a curved portion 51, which in this embodiment begins at the “highest” point of the profile 19 and then transitions into a curved line that slopes to the right in FIG. 4a. The point at the greatest distance from the toothed belt 40 is referred to as the “highest” point of the profile 19.

Two parameters of the curved portion 51 according to the invention are the tangent 53 at the start and the tangent 55 at the end of the curved portion 51.

In this example, the tangents 53 and 55 at the start and end of the portion 51 enclose an angle α of approximately 90°. The angle α enclosed by the tangents 53 and 55 corresponds approximately to the folding angle that is brought about by a folding belt 13, 14.

A third parameter of the curved portion 51 according to the invention is the angle between the tangent 53 at the start and the plane spanned by the toothed belt 40. In the embodiment shown in FIG. 4a, the tangent 53 at the start of the curved portion 51 extends in parallel with the toothed belt 40. In FIG. 4a, the plane in which the toothed belt 40 extends is shown by a line 57.

In this embodiment, the curved portion 51 has the shape of an arc.

The overall height H of the profile 19 and a height H₅₁ of the curved portion 51 are shown in FIG. 4a. In this embodiment, H=H₅₁. In addition, a height H₅₁ of the curved portion 51 is shown.

Correspondingly, an overall width B of the profile 19 and a width B₅₁ of the curved portion 51 are shown in FIG. 4a.

A radius of the curved portion 51 is equal to the overall height H and a width B of the folding belt.

FIG. 4b is the section through the profile 19 in the region along the line B-B. The significant difference is the height greater height of the profile 19. The wedge shape, which can be seen in the side view of the folding belt 13, 14 (see FIG. 3), of the bearing surface 39 is achieved by the height of the profile 19 linearly increasing from the minimum 43 to the apex 42.

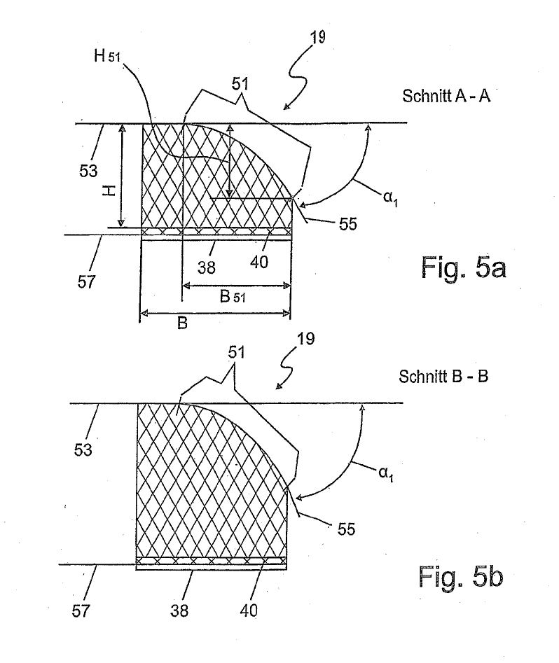

FIGS. 5a and 5b show a further embodiment of a profile 19 according to the invention.

In this embodiment, the curved portion does not extend over the entire width of the toothed belt 40. The tangents 53 and 55 enclose an angle of α₁ of approximately 45°.

The curved portion is elliptical, the profile 19 being curved at the highest point to a lesser extent than in the region of the tangent 55. Here, too, the height of the profile 19 continuously increases.

However, it is also possible to design the curved portion 51 as a parabola or another curved line, preferably in the form of a polynomial of the second order.

In this embodiment, the height H₅₁ of the curved portion 51 is less than the overall height H. H:H₅₁ is approximately equal to 4:3.

In this embodiment, the width B₅₁ of the curved portion 51 is also less than the width B of the folding belt. B:B₅₁ is approximately equal to 4:3.

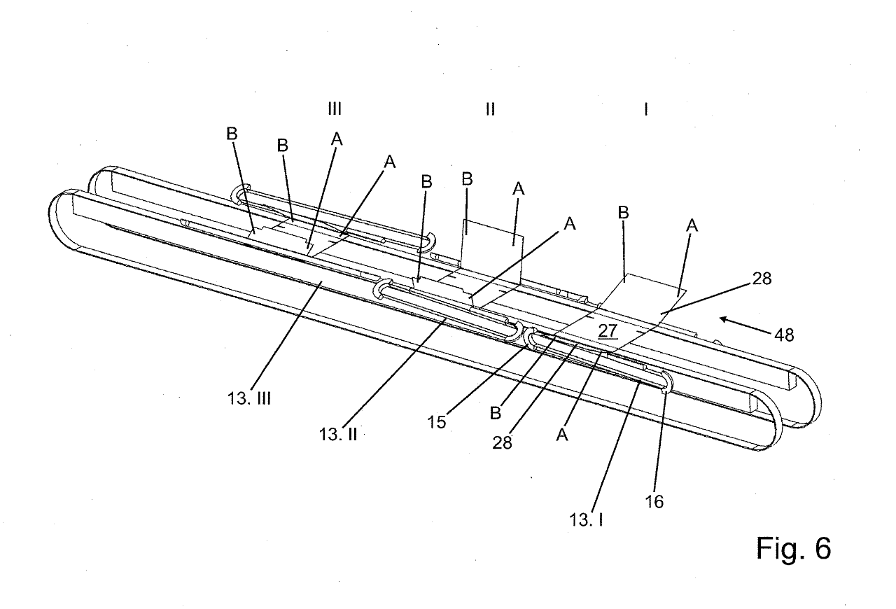

The process of folding a side flap 28 is shown in the following in combination with FIG. 6. In this case, three folding belts 13 are arranged one behind the other on each side. None of the folding belts 13 is crossed.

The side flaps 28 are folded by 180° in three steps I, II and III corresponding to three folding belts 13.I, 13.II and 13.III on each side. So as not to overload the drawing, not all of the parts are provided with reference signs, but instead reference is made to the other drawings.

In step I, the unfolded side flap 28 is folded by an angle of approximately 60°. This is achieved by first folding belts 13.I according to the invention. The pulley 16 arranged further behind is raised relative to the front pulley 15. So that the bearing surface 39 of the folding belt rests against the entire length of the side flap 28, the minimum 34 of the folding belt 13 is behind the apex 42 in the running direction.

In step II, the side flaps 28 are further folded up to an angle of approximately 120°. This is achieved by second folding belts 13.II according to the invention. The pulley 16 arranged further behind is raised relative to the front pulley 15 and is moved in the direction of the plane of symmetry.

Folding is carried out in a similar manner in step III.

In the case of the folding belts 13.II and 13.III used in steps II and III, the minima 43 of the folding belts 13 are arranged in the running direction behind the apex 42.

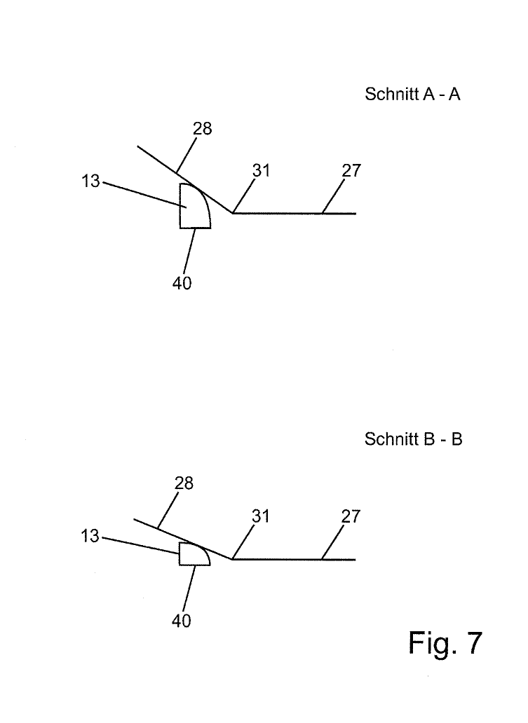

FIG. 7 is partial sections through a folding-box blank and the folding belt 13 according to the invention in two intersection planes A-A and B-B during the first step I (see FIG. 6) by way of illustration.

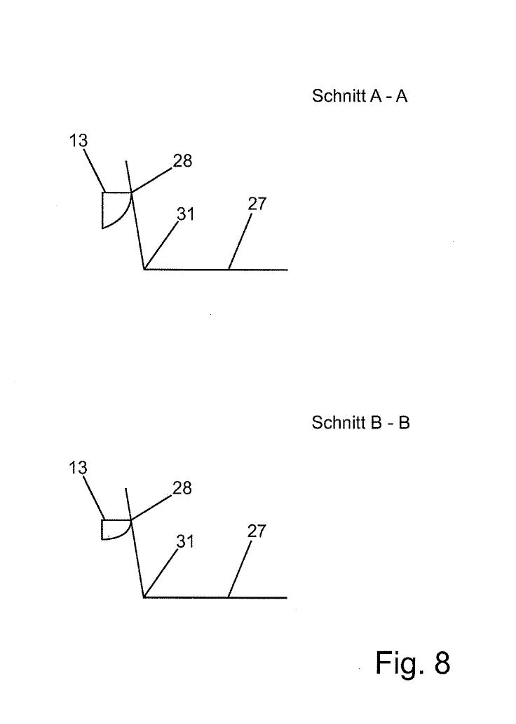

FIG. 8 is partial sections through a folding-box blank and the folding belt 13 according to the invention in two intersection planes A-A and B-B during the second step II (see FIG. 6) by way of illustration.

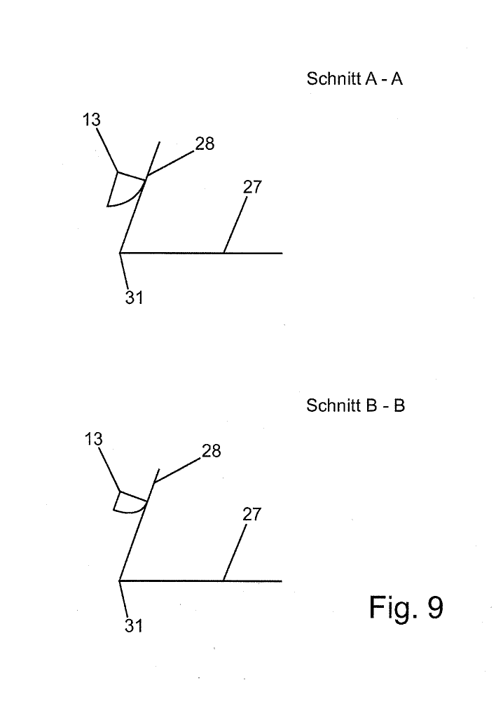

FIG. 9 is partial sections through a folding-box blank and the folding belt 13 according to the invention in two intersection planes A-A and B-B during the third step III (see FIG. 6) by way of illustration.

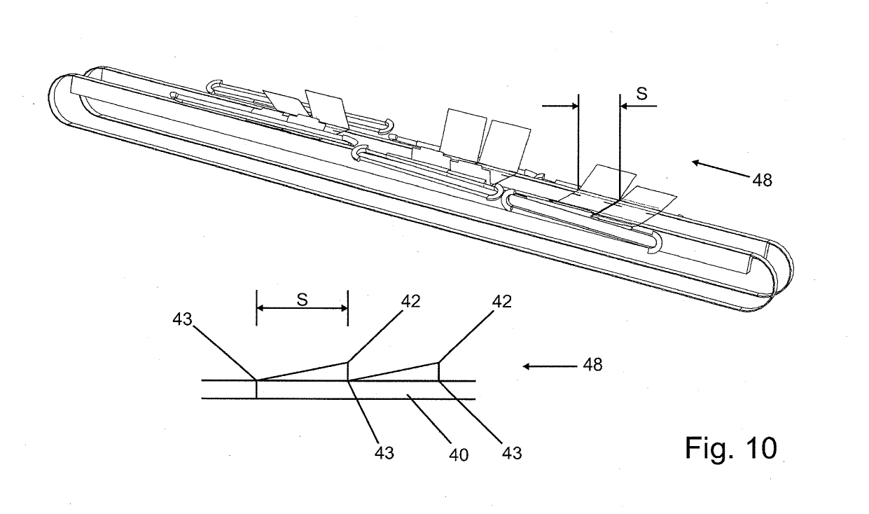

FIG. 10 shows the simultaneous folding of a plurality of folding-box blanks in one step (multi-box method).

As can be seen by comparing FIGS. 6 and 10, the significant difference is that in each of the three steps, two folding-box blanks are folded.

Correspondingly, the folded belts 13 used in the process have the “sawtooth profile” shown in the lower part of FIG. 10. The distance between two minima or two apexes corresponds approximately to the length or the distance S between the front edges of the folding-box blanks.

What is claimed is:

1. Folding belt for use in a device for folding folding-box blanks that are flat in the initial state, the folding belt having a front and a back, the back of the folding belt being provided with a profile that forms a bearing surface for a relevant side flap, is sawtooth-shaped in the longitudinal section with regard to the longitudinal extension of the folding belt, and comprises at least one apex and has a minimum, and the bearing surface being between the leading minimum and the following apex, characterized in that the profile comprising at least one curved portion when viewed in cross section, characterized in that the tangents at the start and end of the curved portion enclose an angle of 90° or less and at least of 30°, in that the tangent at the start of the curved portion and the toothed belt enclose an angle between 5° and 45°, and in that a length of the bearing surface is approximately equal to a length of the side flap to be folded.

2. (canceled)

3. Folding belt according to claim 1, characterized in that the tangent at the start of the curved portion extends in parallel with a toothed belt of the folding belt.

4. (canceled)

5. Folding belt according to claim 1, characterized in that the curved portion has the shape of a circular segment, of an elliptical segment or of another polynomial of the second order.

6. Folding belt according to claim 1, characterized in that a polygon having at least three straight lines is brought into close proximity to the curved portion (51).

7. Folding belt according to claim 1, characterized in that the profile, when viewed in the longitudinal section, forms an oblique rear surface between the apex and the following minimum.

8. Folding belt according to claim 1, characterized in that the folding belt, when seen in the longitudinal direction, comprises a plurality of apexes and associated minima, in that each portion of the profile that begins with a minimum, comprises an apex and ends at the adjacent minimum forms a sawtooth.

9. Folding belt according to claim 1, characterized in that the distance between two adjacent minima is greater than the dimensions of the folding-box blanks, measured in the direction in parallel with the folding lines.

10. Folding belt according to claim 1, characterized in that the apex of each sawtooth is, with regard to the direction of movement of the folding belt, at a distance from the previous minimum that is at least equal to the distance from the minimum following the apex in the direction of movement.

11. Folding belt according to claim 1, characterized in that on the back of the folding belt, the profile consists of a flexible material.

12. Folding belt according to claim 11, characterized in that the profile through supports at least one strip that is made of a flexible material and is upright relative to the back, the free narrow end of which strip facing away from the folding belt forms the bearing surface.

13. Folding belt according to claim 12, characterized in that the strips are arranged so as to be undulating or meandering in the longitudinal direction of the folding belt.

14. Folding belt according to claim 1, characterized in that the folding belt is symmetrical in cross section.

15. Folding belt according to claim 1, characterized in that the flat belt is a toothed belt.

16. Folding belt according to claim 1, characterized in that the distance between two adjacent minima is equal to the dimensions of the folding-box blanks, measured in the direction in parallel with the folding lines.

17. Folding belt according to claim 1, characterized in that the distance between two adjacent minima is smaller than the dimensions of the folding-box blanks, measured in the direction in parallel with the folding lines.
